(19) United States
(12) Patent Application Publication
(10) Pub. No.: US 2026/0366685 A1
(43) Pub. Date: Nov. 19, 2026

(54) LIGHTIG DEVICE FOR A MOTOR VEHICLE

(71) Applicant: VALEO VISION, Bobigny (FR)

(72) Inventors: Christophe DUBOSC, Bobigny (FR); Maxime LAMINETTE, Bobigny (FR)

(73) Assignee: VALEO VISION, Bobigny (FR)

(21) Appl. No.: 19/133,560

(22) PCT Filed: Nov. 16, 2023
(86) PCT No.: PCT/EP2023/082148

§ 371 Date: May 28, 2025

(30) Foreign Application Priority Data
Nov. 30, 2022 (FR) FR2212591

(51) Int. Cl. F21S 41/32

(52) U.S. Cl. CPC F21S 41/321

(57) ABSTRACT

The invention relates to a lighting device for a vehicle. The lighting device includes a housing with an open front face, a primary light source configured to emit primary light rays, a collector configured to generate, from the primary light rays, a first light beam toward an output optical element, with the output optical element arranged on the front face. The lighting device also includes an optical module arranged inside the housing and configured to generate a second light beam toward the output optical element. The output optical element is configured to transmit an overall light beam formed by the first light beam and the second light beam toward the outside of the vehicle.

### TECHNICAL FIELD

The present invention relates to a luminous device for a vehicle. It is particularly applicable, but not limited, to automotive vehicles.

### BACKGROUND OF THE INVENTION

In the field of automotive vehicles, a luminous device for a vehicle that is well known to a person skilled in the art comprises:
a housing with an open front face,
at least one light source configured to emit light rays that reflect off at least one collector,
said at least one collector being configured to generate, from said light rays, a light beam toward an output optical element,
said at least one output optical element comprising a plurality of optical sub-elements and being configured to transmit said light beam toward the outside of said vehicle.

One disadvantage of this aforementioned prior art is that the light beam transmitted by the various output optical sub-elements results in the light seen by an observer looking at it from outside the vehicle having a non-uniform appearance.

In this context, the present invention aims to propose a luminous device for a vehicle that proposes a solution to the abovementioned disadvantage.

### SUMMARY OF THE INVENTION

To this end, the invention proposes a luminous device for a vehicle, said luminous device comprising:
a housing with an open front face,
at least one primary light source configured to emit primary light rays that reflect off at least one collector,
said at least one collector being configured to generate, from said primary light rays, a first light beam and to orient it toward at least one output optical element,
said at least one output optical element being arranged on said front face of said housing,
characterized in that:
said luminous device further comprises an optical module configured to generate a second light beam toward said at least one output optical element, said optical module being arranged inside said housing,
and in that:
said at least one output optical element is configured to generate an overall light beam formed by said first light beam and said second light beam and to transmit it toward the outside of said vehicle.

Thus, as will be seen in detail below, having the second light beam to complement the first light beam will allow the light transmitted by the luminous device to present a uniform appearance.

According to nonlimiting embodiments, said luminous device may further comprise one or more of the following additional features, implemented alone or in any technically possible combination.

According to one nonlimiting embodiment, said optical module is a cylindrical or planar light guide.

According to one nonlimiting embodiment, said at least one output optical element is a lens.

According to one nonlimiting embodiment, said housing comprises a lower part and an upper part and said optical module is arranged on said lower part.

According to one nonlimiting embodiment, said luminous device further comprises at least one secondary light source configured to generate secondary light rays that cooperate with said optical module so as to generate said second light beam.

According to one nonlimiting embodiment, said at least one output optical element comprises optical sub-elements.

According to one nonlimiting embodiment, said housing comprises a lower part and an upper part, and at least one of the lower or upper faces comprises partitions for separating said optical sub-elements of said output optical element.

According to one nonlimiting embodiment, said luminous device comprises a plurality of primary light sources associated with each of the optical sub-elements of said output optical element.

According to one nonlimiting embodiment, said at least one secondary light source is configured to be activated by day when said at least one primary light source is deactivated so that said optical module generates said second light beam.

According to one nonlimiting embodiment, said at least one secondary light source is configured to be activated at night when said at least one primary light source is activated so that said optical module generates said second light beam.

According to one nonlimiting embodiment, said luminous device is a lighting and/or signaling device.

According to one nonlimiting embodiment, the primary light source is a semiconductor light source. According to one nonlimiting embodiment, the secondary light source is a semiconductor light source. According to one nonlimiting embodiment, the semiconductor light source forms part of a light-emitting diode or of a laser diode.

### BRIEF DESCRIPTION OF DRAWINGS

The invention and the various applications thereof will be understood more clearly from reading the following description and studying the accompanying figures:

FIG. 1 is a schematic side view from above of a luminous device comprising a primary light source, at least one collector associated with said primary light source, an optical module with which is associated a secondary light source, and an output optical element, according to one nonlimiting embodiment of the invention;

FIG. 2 is a rear view of the output optical element of the luminous device of FIG. 1, said output element comprising optical sub-elements, according to one nonlimiting embodiment;

FIG. 3 is a perspective view of the luminous device of FIG. 1, according to a first nonlimiting embodiment variant;

FIG. 4 is a perspective view of the luminous device of FIG. 1, according to a second nonlimiting embodiment variant;

FIG. 5 is a front view of a vehicle with headlights comprising a night-time light signature obtained by means of the luminous device of FIG. 1; and

FIG. 6 is a front view of a vehicle with headlights comprising a daytime light signature obtained by means of the luminous device of FIG. 1.

### DETAILED DESCRIPTION OF THE INVENTION

Elements that are identical, in terms of structure or function, and that appear in different figures are denoted by the same reference signs, unless specified otherwise.

The luminous device 1 for a vehicle 2 according to the invention will now be described with reference to FIGS. 1 to 6. In one nonlimiting embodiment, the vehicle 2 is an automotive vehicle. An “automotive vehicle” means any type of motorized vehicle. This embodiment is given as a nonlimiting example in the remainder of the description. In the remainder of the description, the vehicle 2 is thus also referred to as an automotive vehicle 2. The automotive vehicle 2 has a longitudinal axis Ox referred to as the vehicle axis Ox. In one nonlimiting embodiment, the luminous device 1 is a lighting device to which signaling may be added in order to form a lighting and signaling device. In nonlimiting embodiment variants, the luminous device 1 is a headlamp.

As illustrated in FIG. 1, the luminous device 1 comprises:
a housing 10,
at least one primary light source 11,
at least one collector 12 associated with said at least one light source 11,
at least one output optical element 13,
an optical module 14.

In one nonlimiting embodiment, the luminous device 1 further comprises at least one secondary light source 15 associated with said optical module 14.

In one nonlimiting embodiment, the luminous device 1 comprises:
a single primary light source 11,
a single collector 12 associated with said at least one light source 11,
a single output optical element 13.

This nonlimiting embodiment is given as a nonlimiting example in the remainder of the description.

The elements of the luminous device 1 are described in detail below.

As illustrated in FIG. 1, the housing 10 comprises:
a front face 10.1 which is open,
a rear face 10.2 which is closed,
a lower part 10.3,
an upper part 10.4.

The housing 10 is configured to receive the primary light source 11, the optical module 14 and said at least one associated secondary light source 15.

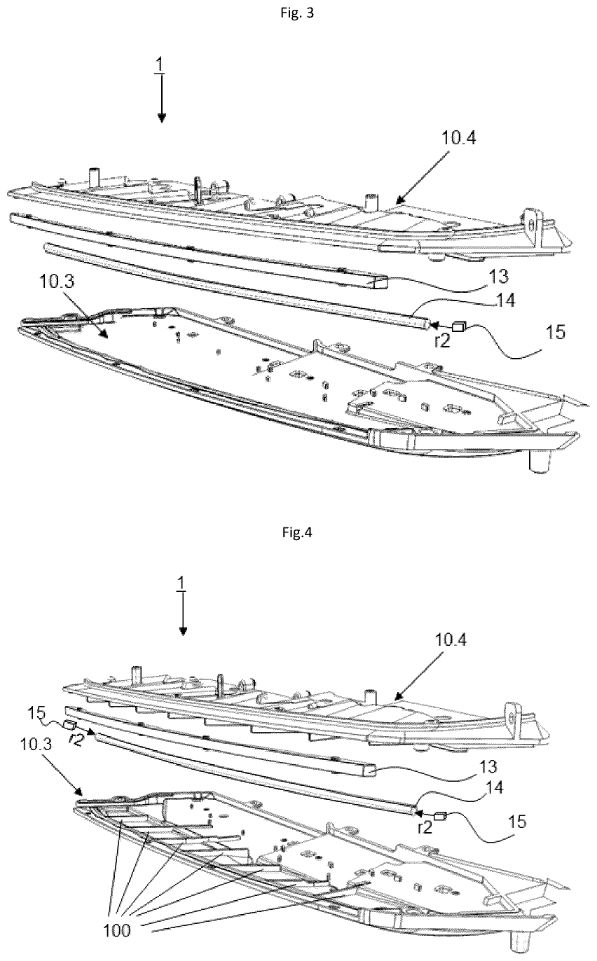

In a first nonlimiting embodiment variant illustrated in FIG. 3, the housing 10 does not have partitions 100.

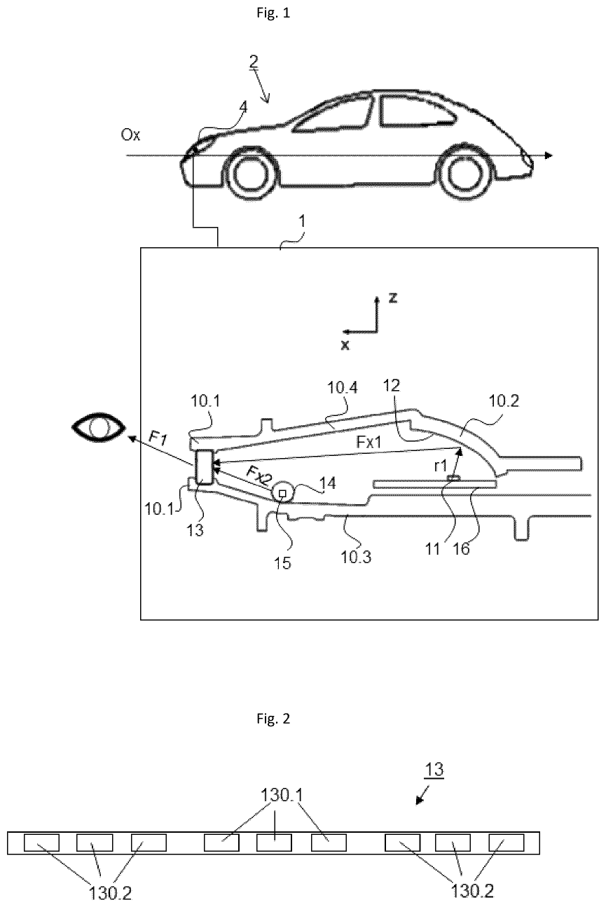

In a second nonlimiting embodiment variant, at least one of the lower 10.3 or upper 10.4 parts of the housing 10 comprises partitions 100 for separating optical sub-elements 130 (illustrated in FIG. 2) of the output optical element 13. In one nonlimiting embodiment, the partitions 100 are distributed equidistantly. As illustrated in the nonlimiting example of FIG. 4, the lower part 10.3 and upper part 10.4 comprise such partitions 100. In this case, it will be noted that the output optical element 13 and the optical module 14 are placed in front of these partitions 100. Specifically, the partitions 100 prevent light coming from a primary light source 11 associated with an optical sub-element 130 from passing through the adjacent optical sub-element. The partitions 100 thus prevent light from escaping from one optical sub-element 130 into another optical sub-element 130. Thus, the partitions 100 allow the light that originates from the optical module 14 to be diffused locally.

In one nonlimiting embodiment, the primary light source 11 is a semiconductor light source. In one nonlimiting embodiment, the semiconductor light source forms part of a light-emitting diode or of a laser diode. A “light-emitting diode” means any type of light-emitting diode, including, by way of nonlimiting example, LEDs (light-emitting diodes), OLEDs (organic LEDs), AMOLEDs (active-matrix organic LEDs), or FOLEDs (flexible OLEDs). The same goes for the secondary light source(s) 15.

As illustrated in FIG. 1, the primary light source 11 is configured to emit primary light rays r1, also called light rays r1, which will reach the collector 12 and be reflected therefrom. In one nonlimiting embodiment, the primary light source 11 is arranged on an electronic support 16, such as, in one nonlimiting example, a PCBA (“Printed Circuit Board Assembly”) board.

The collector 12 comprises a shell-shaped or cap-shaped support, and a reflective surface (not illustrated) on the interior face of the support, the reflective surface having an elliptical or parabolic profile.

The collector 12 is configured to collect the primary light rays r1 and to generate, from said light rays r1, a first light beam Fx1 and orient it toward the output optical element 13. The primary light rays rl reflecting off said reflective surface of the collector 12. When there are a plurality of collectors 12, the collectors 12 together form a reflector referred to as a multi-cavity reflector. The first light beam Fx1 together with the second light beam Fx2 (described below) will form an overall light beam F1 of the luminous device 1. The first light beam Fx1 makes it possible to produce a photometric lighting function f1 and the second light beam Fx2 makes it possible to produce, by night, a proportion of a photometric signaling function f2 (if there is one) and, by day, a proportion of a daytime photometric function f3 (daytime lighting); otherwise referred to as DRL “daytime running light”.

In one nonlimiting embodiment, the overall light beam F1 is a segmented light beam. It is thus possible to turn off certain segments so as not to dazzle a vehicle approaching said automotive vehicle 2 head-on, for example. In this case, the reflective surface of the collector 12 has several vertical sectors.

In a first nonlimiting embodiment, the first light beam Fx1 is a high beam, i.e. a beam with no cutoff.

In a second nonlimiting embodiment, the first light beam Fx1 is a low beam, i.e. a beam with an inclined cutoff and a flat cutoff. The flat cutoff and the inclined cutoff delimit the upper part of the respective portion of the first light beam Fx1. It thus has two parts, these being a first portion (not illustrated) which represents an inclined cutoff referred to as “kinked” having in particular an inclined part; and a second portion (not illustrated) which has a flat cutoff referred to as “flat”. In one nonlimiting embodiment, the inclined cutoff comprises an inclined part and a flat part forming an angle, or kink, between them.

In one nonlimiting variant embodiment of the first nonlimiting embodiment and of the second nonlimiting embodiment, the luminous device 1 is a light of very low height of between 5 and 7 millimeters. In that case, in one nonlimiting embodiment illustrated in FIG. 2, the output optical element 13 comprises optical sub-elements 130 that are adjacent to one another and that each produce a portion of the first light beam Fx1. The latter is composed of a wide sub-beam produced from a plurality of optical sub-elements 130.1 illustrated in FIG. 2 and of a plurality of longer-range sub-beams produced from optical sub-elements 130.2 illustrated in FIG. 2. The optical sub-elements 130.1 and 130.2 are called “spots”. Such an output optical element 13 is called a “line lens”. The various optical sub-elements 130 thus do not all project light in the same way at the same location. The light emitted is thus more or less intense.

In one nonlimiting embodiment, the output optical element 13 is a projection lens, otherwise called a lens. It is a converging projection lens which projects the image of the reflective surface to infinity. In nonlimiting embodiments, the projection lens is plano-convex or convex-convex or a meniscus.

As illustrated in FIG. 1, the output optical element 13 is arranged on the front face 10.1 of the housing 10. The output optical element 13 is configured to generate the overall light beam F1 and transmit it to outside the automotive vehicle 2 relatively along the vehicle axis Ox, said overall light beam F1 being formed by the first light beam Fx1 and the second light beam Fx2.

In one nonlimiting embodiment, the output optical element 13 comprises a plurality of optical sub-elements 130 that allow various sub-functions to be achieved, such as a wide sub-beam and longer-range sub-beams. In this case, in one nonlimiting embodiment, the luminous device 1 comprises a plurality of primary light sources 11 associated with each of the optical sub-elements 130 of said output optical element 13.

It will be noted that when the overall light beam F1 has a first light beam Fx1 composed of two portions, in one nonlimiting embodiment, the luminous device 1 comprises two output optical elements 13, one of which is associated with the first portion of said first light beam Fx1 and the other of which is associated with the second portion of said first light beam Fx1. It will be noted that in this case, in one nonlimiting embodiment, the two output optical elements 13 have the same common longitudinal axis perpendicular to the vehicle axis Ox. This makes it possible to produce a low beam. The first portion represents the inclined cutoff referred to as “kinked”. It is otherwise referred to as the inclined cutoff or kink. The second portion represents the flat cutoff referred to as “flat”. It is otherwise referred to as the flat cutoff or cutoff. In this case, in one nonlimiting embodiment, one collector 12 is used to produce the first (kinked) portion of the first light beam Fx1 and three collectors 12 are used to produce the second (flat) portion of the first light beam Fx1.

As illustrated in FIG. 1, the optical module 14 is configured to generate a second light beam Fx2 toward said output optical element 13. Said second light beam Fx2 thus forms, with the first light beam Fx1, the overall light beam F1 of the luminous device 1.

In order to generate the second light beam Fx2, the optical module 14 is associated with at least one secondary light source 15. In a first nonlimiting embodiment illustrated in FIG. 3, it is associated with a single secondary light source 15. In a second nonlimiting embodiment, it is associated with two secondary light sources 15. The optical module 14 comprises at least one end having a secondary light source 15 arranged facing it. Thus, in the nonlimiting example of FIG. 3, a single secondary light source 15 is arranged facing one of the ends of the optical module 14.

Thus, in the nonlimiting example of FIG. 4, two secondary light sources 15 are arranged facing each of the ends of the optical module 14. They are thus arranged on each side of the optical module 14. The one or more secondary light sources 15 are configured to emit secondary light rays r2 (illustrated in FIGS. 3 and 4) that cooperate with the optical module 14 so as to generate the second light beam Fx2. The secondary light rays r2 enter the optical module 14 via one of its ends and pass through the optical module 14 so as to generate the second light beam Fx2.

The optical module 14 is arranged inside the housing 10. In one nonlimiting embodiment, it is arranged on the lower part 10.3 of the housing 10. This avoids placing it in front of the primary light source 11. Therefore, it does not interfere with the first light beam generated by the collector 12. In addition, there is no need to increase the volume of the housing 10 since there is space in the lower part 10.3 for placing the optical module 14 therein.

In nonlimiting embodiments, the optical module 14 is a cylindrical light guide or a planar light guide. It is thus also called a light guide 14. In the nonlimiting example of FIG. 1, it is cylindrical. As illustrated in FIG. 1, when it is arranged on the lower part 10.3 of the housing 10, the light guide 14 is arranged at a lower level compared to the output optical element 13 and compared to the primary light source 11. As illustrated in FIGS. 3 and 4, the light guide 14 extends along the entire length of the output optical element 13 so that its second light beam Fx2 is able to be distributed over the entire length of the output optical element 13. The light guide 14 is thus configured to illuminate the output optical element 13. It will be noted that the light guide 14 is visible through the output optical element 13.

It will be noted that the light guide 14 illuminates toward the output optical element 13 and does not illuminate toward the collector 12 and the second light beam Fx2 is oriented toward the output optical element 13 and is not oriented toward the collector 12.

In certain nonlimiting embodiments, the optical module 14 is fastened to the housing 10 by rivet heading, fusion bonding, or screw fastening.

In one nonlimiting embodiment, said at least one secondary light source 15 is configured to be activated by day when the primary light source 11 is deactivated so that the optical module 14 generates said second light beam Fx2. Thus, the optical module 14 illuminates the output optical element 13 by day while the primary light source 11 is turned off. It is thus visible through the output optical element 13 and illuminates same.

In one nonlimiting embodiment, said at least one secondary light source 15 is configured to be activated at night when said at least one primary light source 11 is activated so that said optical module 14 generates said second light beam.

Thus, the optical module 14 illuminates the output optical element 13 at night also. It is visible through the output optical element 13 and illuminates same. Thus, when the primary light source 11 is turned on when the automotive vehicle 2 is driving at night, the same appearance is obtained for the light signature as when the automotive vehicle 2 is driving by day, namely when the primary light source 11 is turned off and the daytime running lights called DRL are turned on. It will be noted that the light signature is characteristic of a manufacturer or of a model.

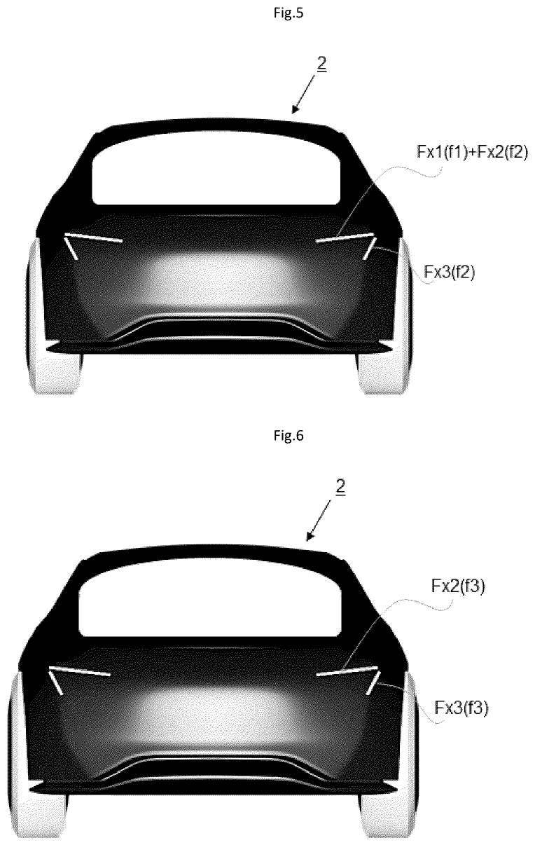

FIG. 5 illustrates a night-time light signature (in the form of an inclined V) of the automotive vehicle 2. It may be seen that the first light beam Fx1 allows the photometric lighting function f1 to be performed, and the second light beam Fx2 allows a portion of the photometric signaling function f2 to be performed, whereas, in one nonlimiting embodiment, the other portion of the photometric signaling function f2 is performed by a third light beam Fx3 generated by a complementary light module (not illustrated) to supplement the night-time light signature. FIG. 6 illustrates a daytime light signature (in the form of an inclined V) of the automotive vehicle 2. It may be seen that if there is no first light beam Fx1, and that the second light beam Fx2 allows a portion of the daytime photometric function f3 to be produced, whereas, in one nonlimiting embodiment, the other portion of the daytime photometric function f3 is produced by the third light beam Fx3 generated by the complementary lighting module (not illustrated) to supplement the daytime light signature.

Moreover, this makes it possible to improve the uniformity of the light emitted by the luminous device 1, namely of the overall light beam F1. Thus, equivalent levels of luminance are obtained regardless of the viewpoint at which an observer (illustrated by an eye in FIG. 1) is positioned in order to observe the luminous device 1 from outside the automotive vehicle 2. Such equivalent levels of luminance corresponds to uniformity of the emitted light, which uniformity is required by automotive vehicle manufacturers. Thus, in particular in the case of a “line” light, the light emitted by the luminous device 1 is no longer non-uniform but uniform, whether the observer is positioned facing the light beam Fx or to the sides, and regardless of viewpoint, whether viewing at a vertical angle or at a horizontal angle. Thus, points of light that are more or less intense because of the sub-beam “spots” described above are no longer seen.

Of course, the description of the invention is not limited to the embodiments described above and to the field described above. Thus, in another nonlimiting embodiment, the output optical element or elements 12 are mirrors rather than projection lenses. Thus, when there are a plurality of collectors 12 and a plurality of primary light sources 11, each collector 12 is associated with a primary light source 11 and is configured to collect and orient its respective primary light rays r1 so as to generate the first light beam Fx1 and orient it toward the one or more output optical elements 13 or toward the optical sub-elements 130 of the output optical element 13.

The invention described thus offers the following advantages in particular:
at night, it makes it possible to give the luminous device 1 a uniform appearance from the point of view of an external observer, and
by day, it allows the luminous device 1 to contribute to the daytime light signature that is very close to the night-time light signature,
it allows the optical module 14 to be integrated at low cost into a pre-existing luminous device 1, and thus makes it possible for the resulting volume of the luminous device 1 not to be increased,
it allows the external appearance of the luminous device 1 to be rendered uniform both by day and at night by virtue of the optical module 14 that is visible directly from outside the vehicle 2,
it makes it possible to obtain a single light signature that is the same both by day and by night.

What is claimed is:

1. A luminous device for vehicle, the luminous device comprising:
a housing with an open front face,
at least one primary light source configured to emit primary light rays that reflect off at least one collector,
the at least one collector being configured to generate, from the primary light rays, a first light beam and to orient it toward at least one output optical element,
the at least one output optical element being arranged on the front face of the housing, and
an optical module configured to generate a second light beam toward the at least one output optical element, the optical module being arranged inside the housing saidwith the at least one output optical element being configured to generate an overall light beam formed by the first light beam and the second light beam and to transmit it toward the outside of the vehicle.

2. The luminous device as claimed in claim 1, wherein the optical module is a cylindrical or planar light guide.

3. The luminous device as claimed in claim 1, wherein the at least one output optical element is a lens.

4. The luminous device as claimed in claim 1, wherein the housing includes a lower part and an upper part and the optical module is arranged on the lower part.

5. The luminous device as claimed in claim 1, further comprising at least one secondary light source configured to generate secondary light rays that cooperate with the optical module so as to generate the second light beam.

6. The luminous device as claimed in claim 1, wherein the at least one output optical element includes optical sub-elements.

7. The luminous device as claimed in claim 6, wherein the housing includes a lower part and an upper part, and at least one of the lower or upper parts includes partitions for separating the optical sub-elements of the output optical element.

8. The luminous device as claimed in claim 7, wherein the luminous device includes a plurality of primary light sources associated with each of the optical sub-elements of the output optical element.

9. The luminous device as claimed in any one of the claim 1, wherein the at least one secondary light source is configured to be activated by day when the at least one primary light source is deactivated so that the optical module generates the second light beam.

10. The luminous device as claimed in claim 1, wherein the at least one secondary light source is configured to be activated at night when the at least one primary light source is activated so that the optical module generates the second light beam.

11. The luminous device as claimed in claim 1, wherein the luminous device is a lighting device or a lighting and signaling device.
